(19) United States
(12) Patent Application Publication
(10) Pub. No.: US 2026/0348541 A1
(43) Pub. Date: Nov. 5, 2026

(54) Method and Apparatus For an Automobile Floor Mat With Ambient Lighting

(71) Applicant: FORTIFY LINER INC., Southwest Covina, CA (US)

(72) Inventor: Yue Kejia, Guangdong (CN)

(21) Appl. No.: 19/279,859

(22) Filed: Jul. 24, 2025

Related U.S. Application Data
(60) Provisional application No. 63/799,705, filed on May 4, 2025.

(51) Int. Cl. F21S 4/28; B60N 3/04; F21V 15/01; F21V 23/00; F21V 23/04; F21W 106/00; F21Y 103/10; F21Y 103/30; F21Y 115/10

(52) U.S. Cl. CPC F21S 4/28; B60N 3/046; B60N 3/048; F21V 15/01; F21V 23/009; F21V 23/0435; F21W 2106/00; F21Y 2103/10; F21Y 2103/30; F21Y 2115/10

(57) ABSTRACT

A lit automobile floor mat that comprises an integrally formed pad body and a light assembly. The mat has a decorative area and a display area. The underside of the mat has a C-shaped channel in about the display area that houses the light assembly. Furthermore, the underside also has supporting ridges that are higher than the C-shaped channel to protect the light assembly from being crushed under pressure.

### INCORPORATION BY REFERENCE

This application claims the benefit of priority under 35 U.S.C. 119(e) to the filing date of U.S. Provisional application No. 63/799,705, entitled “Method and Apparatus For an Automobile Floor Mat With Ambient Lighting,” which was filed on May 04, 2026, and whose entirety is incorporated herein by reference.

### FIELD OF INVENTION

The present invention relates generally to floor mats, and more specifically decorative vehicle floor mats.

### BACKGROUND

The aftermarket, or the secondary market, of automotive parts and equipment, is concerned with the manufacturing, remanufacturing, distribution, retailing, and installation of all vehicle parts, chemicals, equipment, and accessories, after the sale of the automobile by the original equipment manufacturer (OEM) to the consumers. The purchase of such aftermarket parts is a popular way for automobile enthusiasts to personalize their vehicles.

Automobile floor mats are key components that combine both decoration and practicality inside the car. They protect the original car carpet and enhance driving comfort. They are also crucial for driving safety and maintaining interior cleanliness. However, the conventional automotive floor mats cannot emit light or adjust ambiance. For car owners who seek a stylish and atmospheric experience, regular floor mats do not meet their needs.

In recent years, the efficiency and versatility of Light-Emitting Diodes (LEDs) have revolutionized the automotive lighting industry. They offer a wider range of colors, are more energy-efficient, corollarily need only a small and light power source, and have a longer lifespan compared to traditional bulbs. These lights are then controlled by smart lighting systems that employ smart and powerful chips and PCBs that can adjust the lights and light colors automatically based on driving conditions, ambient light, and even the driver's mood. Some systems can also be controlled via smartphone apps or voice commands. These lights can also be easily customized. Thus, options for decorative lights are virtually limitless. Drivers can choose from a wide range of colors, patterns, and brightness levels to create a unique look for their vehicle. To overcome the limitations of existing automotive floor mats that lack lighting or ambiance adjustment, it is desirable for a solution that both aesthetically pleasant, “intelligent”, energy-efficient, and customizable for retail, end-user self installment. The present invention meet all these needs with its apparatus and method for a decorative automotive floor mat with ambient lighting.

### OBJECTIVE OF THE INVENTION

It is an object of this invention to provide a user-friendly automobile floor mat that the user can easily modify its display color and pattern.

It is an object of this invention to provide an intelligent automobile floor mat that the user can wirelessly command status changes of its display color and pattern.

It is an object of this invention to provide an intelligent automobile floor mat that the user can use a mobile device and common wireless communication technologies to command status changes of its display color and pattern.

It is also an object of this invention to provide an energy-efficient automobile floor mat.

It is an object of this invention to a customizable automobile floor mat for retail, end-user self installment.

It is a further object of this invention to provide the method to provide and use a decorative automobile floor mat.

### SUMMARY OF THE INVENTION

This invention is directed to a lit automobile floor mat apparatus that comprises an integrally molded mat body, a top and a underside, a decorative area and a translucent display area, a C-shaped channel, and supporting ridges. These supporting ridges are disposed on the underside and support the body under a pressure.

The invention further comprise a lighting assembly that in turn comprises a light strip and an elastic wrapper with a groove. This elastic wrapper in turn comprises a channel that houses the light strip. The C-shaped channel comprises a ridge running along its inner wall, that mates with the groove of the elastic wrapper when the lighting assembly is installed and secures the lighting assembly inside the C-shaped channel. In another embodiment, the elastic wrapper further comprises light-guiding holes disposed along its length and the light-guiding holes diffuse the light strip’s emitted light.

In another embodiment, the supporting ridges are taller than the C-shaped channel to protect the light assembly under a pressure.

In another embodiment, the decorative area and the display area form an anti-slip surface.

In another embodiment, the mat body is made of thermoplastic elastomer.

In another embodiment, this invention further comprises a controller component that is electrically connected to the lighting assembly. The controller component in turn comprises a communication module that wirelessly communicates with and receives commands from a user’s device.

In another embodiment, the controller component further comprises a sound module that senses and interprets certain sound signals and responds by causing the light strip to change its state.

and a lighting assembly.

In another embodiment, the display area’s thickness is thinner than that of the decorative area.

This invention is also directed to a method for providing a lit automobile floor mat that comprises providing an integrally molded mat body that comprises a top and a underside, a decorative area and a translucent display area, a C-shaped channel with a ridge that runs along its inner wall, and supporting ridges on the underside. The method also provides a lighting assembly, a light strip and an elastic wrapper with a groove. The method further provides a controller component that is electrically connected to the lighting assembly. The C-shaped channel is disposed on the underside of the display area and houses the lighting assembly. The elastic wrapper comprises a channel that houses the light strip. The ridge of the C-shaped channel mates with the groove of the elastic wrapper when the lighting assembly is installed and secures the lighting assembly inside the C-shaped channel. The supporting ridges supports the body under a pressure and are taller than the C-shaped channel to protect the light assembly under the pressure.

In another embodiment, the method further provides a elastic wrapper with light-guiding holes disposed along its length. These light-guiding holes diffuse the light strip’s emitted light.

In another embodiment, the method provides the decorative area and the display area as an anti-slip surface. In another embodiment, the method provides the mat that is made of thermoplastic elastomer.

In another embodiment, the method further provides a communication module that wirelessly communicates with and receives commands from a user’s device.

In another embodiment, the method further provides a sound module that senses and interprets certain sound signals and responds by causing the light strip to change its state.

### BRIEF DESCRIPTION

The present invention will be understood and appreciated more fully from the detailed description taken in conjunction with the drawings in which:

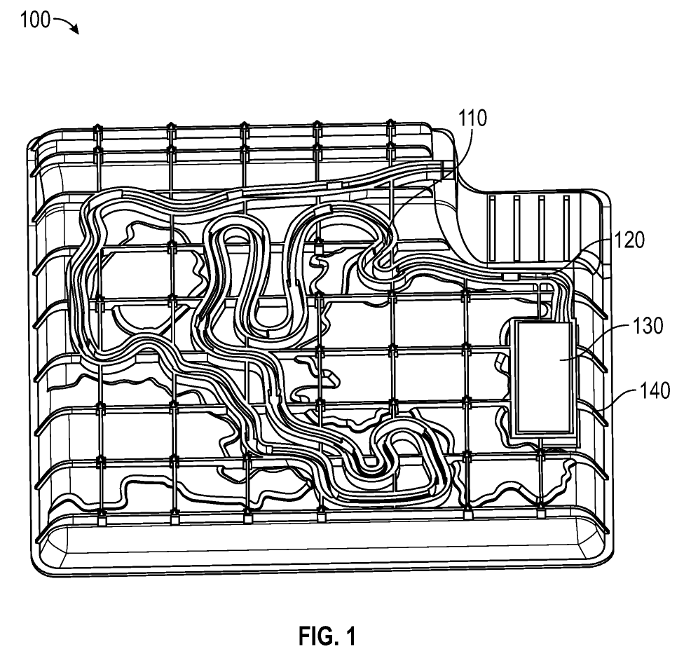

FIG. 1 illustrates the underside of an exemplary embodiment of the present invention that discloses the subject structure in detail.

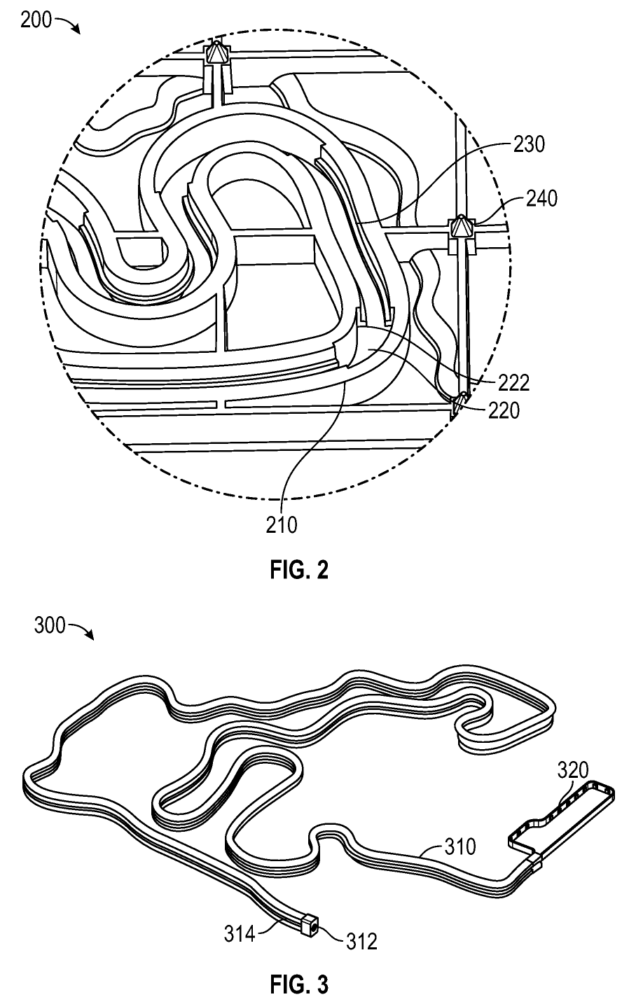

FIG. 2 is a partial view of an exemplary embodiment of the present invention that discloses the light assembly as it is installed in the C-shaped channel of the embodiment.

FIG. 3 discloses the structure of the light assembly of an embodiment of the present invention.

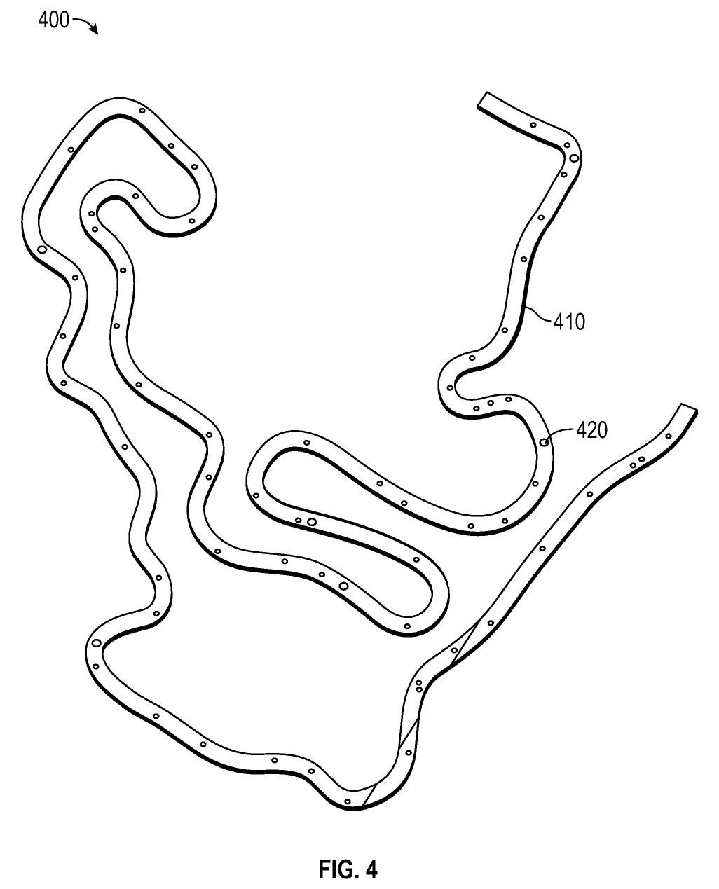

FIG. 4 discloses the elastic wrapper which wraps the light strip of an embodiment of the present invention.

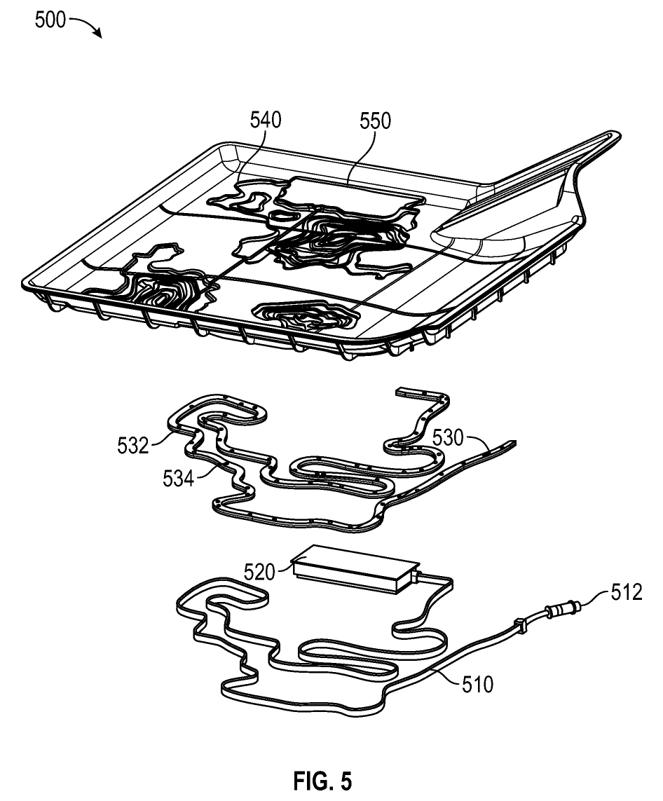

FIG. 5 illustrates an exploded view of an embodiment of the present invention.

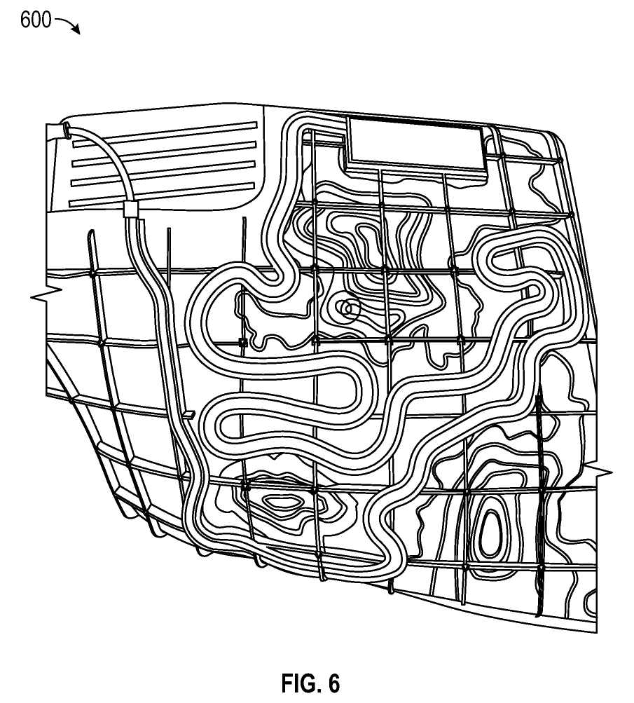

FIG. 6 illustrates the underside of another embodiment of the present invention that is fully assembled.

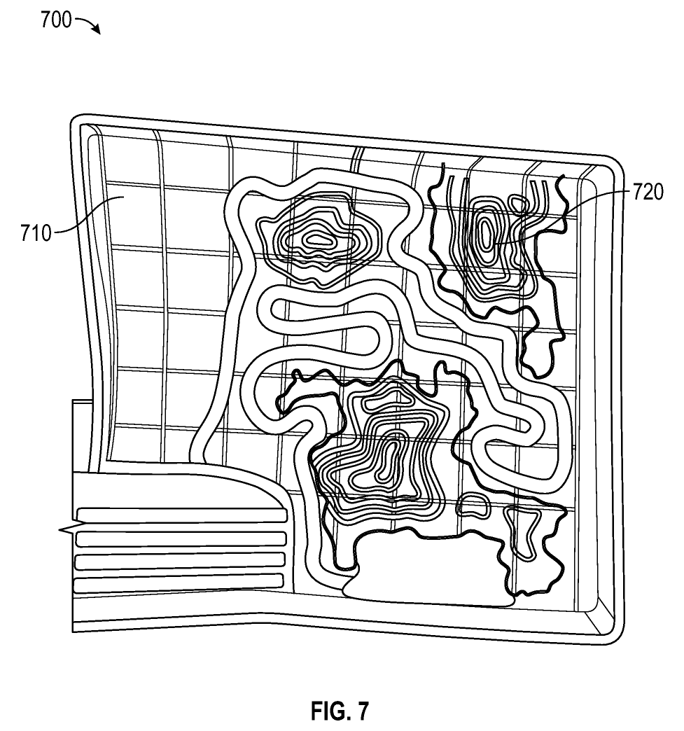

FIG. 7 illustrates a partially transparent top of an embodiment of the present invention.

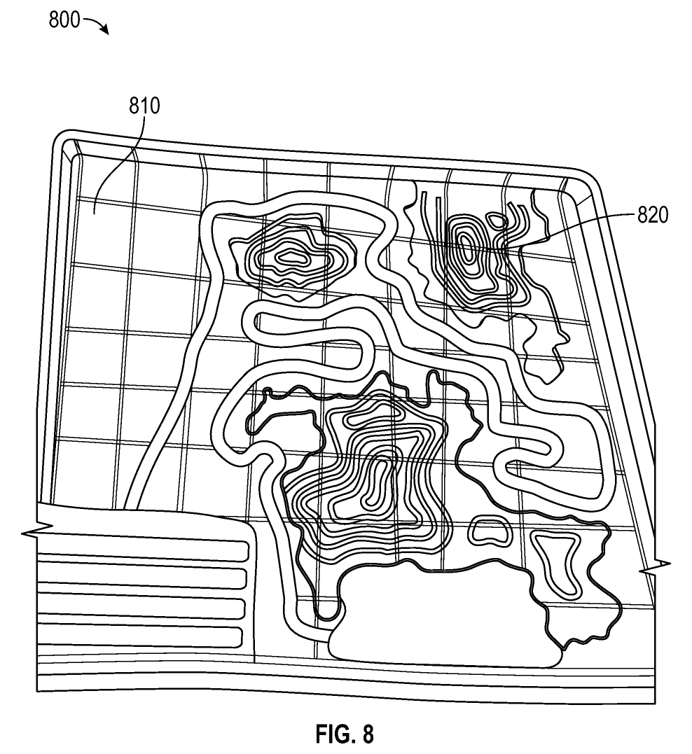

FIG. 8 illustrates a semi-opaque top of another embodiment of the present invention.

### DETAILED DESCRIPTION

The invention will be described in the context of a preferred embodiment.

Referring to FIG. 1, the underside of an embodiment 100 of the present invention is shown. As shown, the floor mat 100 comprises a C-shaped channel 110 that is molded with the mat 100 in a predefined pattern. The channel 110 houses a light assembly 120 within its channel. The mat 100 further comprises a controller component 130 that controls and causes the light assembly to turn on/off and emit light in a pattern. The mat 100 further comprises supporting ridges 140 that are also molded together with the mat and form a lattice to make the mat firmer and can support the mat under pressure. It is appreciated that the ridges are either higher or equal to the height of the C-shaped channel, such that when the mat is under pressure, the supporting ridges will provide the counter force and protect the C-shaped channel and the lighting assembly from being crushed. The mat 100 is further molded slightly curved up as a tray mat that catches dust, debris, etc. It is appreciated that the mat and the mat lips are molded to fit certain vehicles’ footwell.

FIG. 2 discloses a close-up structure of an exemplary mat 200 of the present invention. The mat 200 comprises a C-shaped channel 210 that comprises a channel 220 that in turn houses a light assembly 230. The channel 220 has a ridge 222 that is disposed in and running along a wall of the channel. This ridge 222 mates with a groove on the side of the light assembly and as such secures the light assembly inside the channel. The light assembly has a slightly smaller dimension than that of the channel so it fits snugly inside the channel. Like the embodiment disclosed in FIG. 1, this embodiment also comprises supporting ridges 240.

FIG. 3 illustrates an exemplary light assembly 300 for a mat of the present invention. The light assembly comprises an elastic wrapper 310 that encloses a light strip 320 inside its channel 312. The wrapper has a long groove 314 running along its outer wall. This groove 314 will mate with the ridge inside the C-shaped channel disclosed in FIG. 2, and together the coupling of the ridge and groove secures this light assembly 300 inside a C-shaped channel of the present invention. It is appreciated that the light strip is made of LED chips stringed together, and they can be single color, RGB, or other similar variant.

FIG. 4 discloses an exemplary wrapper 400 for a mat of the present invention. The wrapper 400 comprises similar elements as disclosed in FIG. 3 such as being elastic and having a groove 410 on its side. This wrapper embodiment further comprises holes 420 at different points along its length. The holes are positioned in a predefined pattern to emit light that fits the design of a mat of the present invention.

FIG. 5 illustrates an exploded view of an embodiment 500 of the present invention. FIG. 5 discloses all the components of the mat 500 and how they are put together. First, the light strip 510 which comprises an electrical connector 512 on its one end for receiving power. The other end of the light strip is connected to the controller 520. Besides a control module that causes the light to turn on/off and display light patterns, this controller also has a wireless communication module that can send status information to a user and receive commands from the user. In another embodiment, the controller can also have a sound module that can detect and interpret sounds, and cause the light strip to change its state, such as turning on/off, displaying a certain pattern of light. Second, the light strip 510 is wrapped inside the wrapper 530 to form a light assembly. As disclosed in FIG. 4, the wrapper 530 has a groove 532 running along its length and holes 534 on its body. Third, the light assembly is inserted into the C-shaped channel 540 on the underside of the mat 500. Fourth, the controller 520 is placed and secured inside the housing 550.

FIG. 6 shows a fully assembled embodiment 600 of the present invention. All the elements of the mat 600 are disclosed above in FIGS. 1-5, such as the C-shaped channel, the light assembly with its wrapper, the controller being installed inside its housing, and the light strip’s power connector being connected to an external power supply. The mat 600 is molded with a lattice of ridges that make the mat more rigid and stronger to withstand pressure without the light assembly being crushed.

FIG. 7 discloses an exemplary embodiment 700 of a mat of the present invention. Specifically, FIG. 7 discloses a mat with a partially transparent top that allows stronger light emission and a clearer display of the art design. The embodiment also comprises a partially transparent display area 710 and a decorative area 720 that is opaque. Furthermore, when this mat is molded, the decorative area is molded thicker than the display area, and, thus, it is more opaque. It is appreciated that the art design varies and can easily be changed to meet the needs of users.

FIG. 8 discloses another embodiment 800 of a mat of the present invention. This embodiment has an almost opaque top that allows less light emission and, as a result, the display of the art design will be dimmer. Like the embodiment disclosed in FIG. 7, this embodiment is also molded with a display area 810 and a decorative area 820. Similarly, the decorative area is molded thicker than the display area.

1. A lit automobile floor mat apparatus comprising
an integrally molded mat body and a lighting assembly;
wherein said body comprises a top side and an underside;
wherein said body further comprises a decorative area and a translucent display area;
wherein the underside of said display area comprises a C-shaped channel configured to house said lighting assembly.

2. The apparatus of claim 1, wherein said lighting assembly comprises a light strip enclosed by an elastic wrapper having a groove;
wherein said C-shaped channel comprises a ridge running along an inner wall thereof;
wherein said ridge is configured to mate with said groove to secure said lighting assembly within said C-shaped channel.

3. The apparatus of claim 2, wherein said elastic wrapper comprises a channel that houses said light strip.

4. The apparatus of claim 2, wherein said elastic wrapper further comprises a plurality of light- guiding holes disposed along a length thereof, configured to diffuse light emitted by said light strip.

5. The apparatus of claim 1, wherein said underside further comprises supporting ridges configured to support said mat body under pressure.

6. The apparatus of claim 5, wherein said supporting ridges are taller than said C-shaped channel to protect said lighting assembly from pressure.

7. The apparatus of claim 1, wherein said decorative area and said display area form an anti-slip surface.

8. The apparatus of claim 1, wherein said mat body is made of thermoplastic elastomer.

9. The apparatus of claim 1, further comprising a controller component electrically connected to said lighting assembly;
wherein said controller component comprises a communication module configured to wirelessly communicate with and receive commands from a user device.

10. The apparatus of claim 9, wherein said controller component further comprises a sound module configured to detect and interpret sound signals and, in response, cause said light strip to change its state.

11. The apparatus of claim 1, wherein said display area has a thickness less than that of said decorative area.

12. A method of manufacturing a lit automobile floor mat, comprising:
providing an integrally molded mat body comprising a top side, an underside, a decorative area, a translucent display area, a C-shaped channel having a ridge along an inner wall, and supporting ridges;
providing a lighting assembly;
providing a light strip and an elastic wrapper having a groove;
providing a controller component electrically connected to said lighting assembly;
wherein said C-shaped channel is disposed on the underside of said display area and is configured to house said lighting assembly;
wherein said elastic wrapper comprises a channel that houses said light strip;
wherein said ridge is configured to mate with said groove to secure said lighting assembly within said C-shaped channel;
wherein said supporting ridges are taller than said C-shaped channel and support said body under pressure to protect said lighting assembly.

13. The method of claim 12, further comprising providing a plurality of light-guiding holes disposed along said elastic wrapper;
wherein said light-guiding holes are configured to diffuse light emitted by said light strip.

14. The method of claim 12, wherein said decorative area and said display area form an anti-slip surface.

15. The method of claim 12, wherein said mat body is made of thermoplastic elastomer.

16. The method of claim 12, further comprising providing a communication module configured to wirelessly communicate with and receive commands from a user device.

17. The method of claim 12, further comprising providing a sound module configured to detect and interpret sound signals and, in response, cause said light strip to change its state.
